(19) United States
(12) Patent Application Publication
(10) Pub. No.: US 2013/0209371 A1
(43) Pub. Date: Aug. 15, 2013

(54) Germ Solve Candle

(71) Applicant: Mark Anthony Willis, Columbia, SC (US)

(72) Inventor: Mark Anthony Willis, Columbia, SC (US)

(21) Appl. No.: 13/670,720

(22) Filed: Nov. 7, 2012

Related U.S. Application Data
(60) Provisional application No. 61/633,671, filed on Feb. 15, 2012.

(51) Int. Cl. A01N 65/00

(52) U.S. Cl. CPC A01N 65/00
USPC 424/40; 264/279

(57) ABSTRACT

A candle is provided which includes a unique blend of ingredients that been formulated to reduce a broad spectrum of germs in the area of the candle of the present invention, as well as weakening the spread of infectious contaminates imposed by coughing and sneezing, in the area surrounding the candle of the present invention.

### CROSS REFERENCE TO RELATED APPLICATION

This application claim the priority of provisional application No. 61/633,671 filing date of: Feb. 15, 2012, Mark A. Willis, 2301 lorick ave. Columbia, S.C. 29203

### STATEMENT OF FEDERALLY SPONSORED RESEARCH/DEVELOPMENT

Not Applicable

### REFERENCE TO A “SEQUENCE LISTING”

Not Applicable

### BACKGROUND OF THE INVENTION

The present invention relates to a candle and more particularly to a candle with a unique blend of ingredients, (essential oils and their constituent compounds), that when lit reduces a broad spectrum degree of pathogens, commonly known as “germs”, helping to aid in stopping and or slowing down the spread of germs in the area surrounding the candle of the present invention, germs which can cause sickness in humans.

Microorganisms, or microbes as they are often called, are living microscopic (too small to be seen by the naked eye) organisms that take in food and give off waste, grow, reproduce and die. Microbes are everywhere, in the environment all around us, and within each one of us there are trillions and trillions of them. Thankfully, most microorganisms do not cause harm, and many are indispensable to our survival.

When microorganisms are harmful and cause sickness, infection and disease, they are called “pathogens”. “Patho” is Greek for suffering, and “gen” is a suffix meaning producer. Pathogens are more commonly called “germs”.

Germs can be classified into four major groups: Virus, Bacteria, Fungi, and Parasites.

The most common way of becoming infected with a germ is by catching it from another person who is already infected. Studying a germ's movement from one person or population to another is called epidemiology (from the Greek words “epi” meaning “on” and “demos” meaning “people”).

Examples of germs we catch from others includes the common cold or flu, chicken pox and strep throat. One of the mode of infection can be from airborne transmission, by the way of droplets.

Droplets are mucus secretions that are emitted into the air by coughing or sneezing. When a sick person emits droplets into the surrounding area they have the potential to infect others close by. Theses droplets are too heavy to stay suspended in air for long period of time and as a result they can only travel up to 3 feet, while certain germs can travel longer than 3 feet by attaching to droplets of moisture in the air or to dust particles, which then is inhaled by other people, in this way they can travel very long distances.

Modern research has proven the effectiveness of certain essential oils and their ability to eliminate harmful microorganism's by the use of a candle flame and specific antibacterial compounds, such as essential oils and their constituent compounds.

The study demonstrates the antibacterial properties of ionization products from a candle flame combined with certain essential oils significantly reduce the germs that it was exposure to in a larger air-tight chamber.

Each essential oil tested, has its own performance level on eliminating certain types of germs, for example, thyme essential oil perform well against bacteria, while lavender essential oil perform well against fungi and wild oregano oil perform well against parasites.

The problem solved by the present invention lies within its unique blend of essential oils and their constituent compounds, giving the candle of the present invention the ability to eliminate germs effectively in all four major groups, virus, bacteria, fungi and parasites, as well as weakening the spread of infectious contaminates imposed by coughing and sneezing, in the area surrounding the candle, when the candle of the present invention is lit.

It is therefore the principal object of the present invention to provide a candle using traditional candle making materials, along with its unique blend of ingredients that when lit reduces a broad spectrum of germs in the area surrounding the candle of the present invention.

### BRIEF SUMMARY OF THE INVENTION

The present invention is a candle with a unique blend of ingredients, essential oils and their constituent compounds, known for their anti-microbial ability. The unique blend of ingredients have been formulated to reduce germs in all four groups, virus, bacteria, fungi and parasites, as well as weakens the spread of infectious contaminates imposed by coughing and sneezing, around the area of the candle of the present invention.

This germicidal effect accrues through the direct vapor adsorption of the unique blend of essential oils and their constituent compounds onto microorganisms being promoted through the impingement and action of ion's from the candle flame of the present invention.

### DETAIL DESCRIPTION OF THE INVENTION

The present invention is a candle with a unique blend of ingredients for the propose of reducing the spread of germs as well as weakening the spread of infectious contaminates imposed by coughing and sneezing, in the area surrounding the candle of the present invention.

The preferred embodiment consist of a candle body which can be made from a number of combustible materials, such as paraffin wax, soy wax, palm wax, bee's wax, gel wax, synthetic wax or synthesized waxes and any mixtures thereof.

The wax of the preferred embodiment is melted, added to the melted wax is the unique blend of essential oils with their constituent compounds.

Essential oils “also called volatile oils” are aromatic oily liquids obtained from plant materials, flowers, buds, seeds, leaves, twigs, bark, herbs, wood, fruits and roots. They can be obtained by expression, fermentation or extraction but the method of steam distillation is most commonly used for commercial production.

The unique blend of essential oils in the preferred embodiment are; wild oregano oil, thyme oil, tea tree oil, clove bud oil, cinnamon oil, lavender oil, lemon oil and orange oil.

Wild oregano oil has been scientifically researched and proven to be one of the strongest and most effective broad spectrum antimicrobials known to man, it is natural and safe to use, it effectively kills bacteria of every variety using only tiny amounts.

Vapor test studies, show oregano oil diffuses more efficiently through the air than through direct contact with bacteria.

Oregano oil main constituents consisting essentially of carvacrol, thymol, limonene, pinene, ocimene, and caryophyllene.

Thyme oil has been scientifically researched and proven to possess a wide range spectrum of fungicidal activity. The vaporous phase of the oil in low concentration exhibited long-lasting suppressive activity on moulds from damp dwellings.

Thyme oil main constituents consisting essentially of a-theorem, a-pinene, camphene, b-pinene, p-cymene, a-terpinene, linalool, borneol, b-caryophyllene, thymol and carvacrol.

Tea tree oil used in the U.S. in a wide range of products, such as antiseptic and antifungal solutions, inhalers, vaporizers, shampoos, soaps, lotions, deodorants, mouthwashes, toothpaste, disinfectant sprays and air-conditioning duct disinfectant. Tea tree oil is very effective against three categories of infectious organisms. Scientific research has found tea tree oil to have a broad-spectrum of antibacterial, antifungal and antiviral activity. The vapors of tea tree oil has been proven to clean germs and molds in indoor air, the oil and its vapors penetrate into porous materials, where they provide a lasting protection. Research has also proven that tea tree oil destroys both gram negative and gram positive bacteria, even stubborn germs like staphylococcus aureus, pseudomonas aeruginosa and escherichia coli.

The following list of harmful microorganisms tea tree oil is effective against are;

1) fungi and yeasts; aspergillus niger, aspergillus flavus, candida albicans, pityrosporum ovales (molasses furfur), trichophyton mentagrophytes and trichophyton rubrum.
2) gram positive bacteria; bacillus cereus, bacillus subtilis, corynebacterium spp., micrococcus luteus, propionibacterium acnes, methicillin resistant staphylococcus aureus (nctc 4163) (staph infection), staphylococcus epidermis (staph infection) and enterococcus faecalis.
3) gram negative bacteria; enterobacter aerogenes, escherichia coli (e. coli), klebsiella spp, pseudomonas aeruginosa (atcc9027), pseudomonas putida and shigella sonnei.

Tea tree oil main constituents consisting essentially of; terpinen-4-ol, y-terpinene, a-terpinene, 1,8-cineole, a-terminal, a-pinene and p-cymene.

Clove bud oil has been scientifically proven to eliminate unfriendly bacteria and viruses and also possess strong anti-parasitic properties.

Clove bud oil main constituents consisting essentially of; euqenol, eugenyl acetate, caryophyllene and isocaryophyllene.

Cinnamon oil not only smells good, but has been scientifically proven to reduce the risk of pathogen growth on Surfaces by direct and indirect contact, by its emanating vapors even at low concentrations, studies also shown cinnamon oil have natural insecticidal properties.

Cinnamon Oil main constituents consisting essentially of; cinnamaldehyde, eugenol and linalool.

Lavender oil is traditionally used in making perfumes, but it also extensively used for various respiratory problem, including throat infections, flu, cough, cold, asthma, sinus congestion, bronchitis, whooping cough, laryngitis, and tonsillitis, the oil can be used in form of vapor, and is also added in many vaporizer's and inhalers used for cold and coughs.

Scientific studies has shown lavender oil to have good effects against pathogenic bacteria, such as the strains responsible for diseases like diphtheria and typhoid, it is very potent against the streptococcus and pneumococcus strains of bacteria.

Lavender oil main constituents consisting essentially of linalool, linalyl acetate, a-pinene, limonene, cineole, octanone, camphor, caryophyllene,terpinen and lavendulyl acetate.

Lemon oil is proven to be an excellent anti-fungal, anti-bacterial, and anti-viral agent, diffuse vapors of lemon oil purifies the air.

Lemon oil main constituents consisting essentially of; limonene, citral, geranial, citronellal acetate, and Pinene.

Orange oil scientific studies has shown that the vapor diffused from the oil are very effective at killing pathogens in the air, in clinical testing orange oil exhibited absolute fungi toxicity.

Orange Oil main constituents consisting essentially of; limonene, a-pinene, sabinene and b-pinene, myrcene, octanal, linalool, carene and decanal.

Table 1: In one embodiment of the invention the following material within range are used; golden brands 464 soy wax, with maximum oil retention of 12% or 2 oz per pound of wax, the unique blend of essential oils; wild oregano oil 2%, thyme oil 2%, tea tree oil 2%, clove bud oil 2%, cinnamon oil 1%, lavender oil 1%, lemon oil 1% and orange oil 1%.

The percentage amount of each essential oil employed to the unique blend of essential oils varies depending on the “scent desired”, explained in “example 1”.

The candle body may be formed using existing processes known in the art, such as, liquid pouring and molding, wax bead compression, and wax bead extrusion.

The preferred embodiment of the present invention uses liquid pouring and molding.

The list in table 1, the wax is melted, added to the melted wax is the unique blend of essential oils, these materials are mixed into a homogenous liquid state creating a molted blend, the molted blend is then poured into its permanent mold, a pre-wax can 26, 6″ tabbed wick is inserted into the middle of the permanent mold, and set aside to harden. After the preferred embodiment of the present invention is harden, the wick is then trim down to size, to allow proper burning.

The candle of the preferred embodiment is manufactured in a variety of scent desired, the percentage amount employed of each constituent to the unique blend of essential oils of the preferred embodiment is determine by “scent desired”, though the scent desired process.

Example 1; example of scent desired process; for a more citrus scent desired, the percentage amount of orange oil employed to the unique blend of essential oils would be greater than the percentage amount of lavender oil employed to the unique blend of essential oils, and for a more holiday scent desired, the percentage amount of cinnamon oil employed to the unique blend of essential oils would be greater than the percentage amount of lemon oil employed to the unique blend of essential oils, and for a more flower scent desired, the percentage amount of lavender oil would be added in a greater amount to the unique blend of essential oils.

Scent desired method remains true with each constituent in the unique blend of essential oils in the preferred embodiment, when determining scent desired. this method allows the unique blend of essential oils to produce different scents are “scent desired”, when creating the scent or fragrance of the present invention.

Additives known in the art of candle making such as wax hardeners, uv protectors are added according to type of candle.

Type of candle can be classified as; votive, tapers, pillars, jar, containers, tea light, gels and Floating candle type.

Dyes are used to match color with scent or fragrance.

While the foregoing invention has been described in light of its preferred embodiments, various alterations and modification will occur to those skilled in the art, all such alteration and modifications are intended to fall within the scope of the appended claims.

What I claim as my invention is:

1. A germ solving candle, comprising candle body made from a number of materials, in the preferred embodiment consisting essentially of wax, a unique blend of essential oils with their constituent compounds and at least one combusting device, wherein the wax is melted, added to the wax is the unique blend of essential oils with their constituent compounds, these materials are mixed into a homogenous liquid state, creating a molted blend, the blend is then poured into a mold, a wick is inserted, then the candle of the present invention is set aside to harden.

2. A germ solving candle comprising unique blend of essential oils as claimed in claim 1, consisting essentially of wild oregano oil, thyme oil, clove bud oil, tea tree oil, cinnamon oil, lavender oil, lemon oil and orange oil.

3. A germ solving candle comprising a unique blend of essential oils and their constituent compounds as claimed in claim 1, consisting essentially of;
a) wild oregano oil main constituent compounds consisting essentially of carvacrol, thymol, limonene, pinene, ocimene and caryophyllene;
b) thyme oil main constituent compounds consisting essentially of a-theorem, a-pinene, camphene, b-pinene, p-cymene, a-terpinene, linalool, borneol, b-caryophyllene, thymol and carvacrol;
c) tea tree oil main constituent compounds consisting essentially of terpinen-4-ol, y-terpinene, a-terpinene, 8-cineole, a-terminal, a-pinene and p-cymene;
d) clove bud oil main constituents compounds consisting essentially of euqenol, eugenyl acetate, caryophyllene, and isocaryophyllene;
e) cinnamon oil main constituents compounds consisting essentially of cinnamaldehyde, eugenol and linalool;
f) lavender oil main constituents compounds consisting essentially of linalool, linalyl acetate, a-pinene, limonene, cineole, octanone, camphor, caryophyllene, terpinen and lavendulyl acetate;
g) lemon oil main constituents compounds consisting essentially of limonene, citral, geranial, citronellal acetate, and pinene; and
h) orange oil main constituents compounds consisting essentially of limonene, a-pinene, sabinene, b-pinene, myrcene, octanal, linalool, carene, and decanal.

4. A germ solving candle comprising unique blend of essential oils with their constituent compounds as claimed in claim 3, wherein can be formulated consisting essentially of the unique blend of essential oils main constituent compounds.

5. A germ solving candle comprising unique blend of essential oils with their constituent compounds as claimed in claim 3, wherein can be formulated consisting essentially of their synthetic counterparts.

6. A germ solving candle comprising unique blend of essential oils with their constituent compounds as claimed in claim 3, wherein can be formulated consisting essentially of their natural derivatives.

7. A germ solving candle comprising unique blend of essential oils with their constituent compounds as claimed in claim 1, such that when lit, emanating vapors reduces germs in all four groups; virus, bacteria, fungi and parasites.

8. A germ solving candle comprising unique blend of essential oils with their constituent compounds as claimed in claim 1, such that when lit, emanating vapors weakens the spread of infectious contaminates imposed by coughing and sneezing.

9. A germ solving candle comprising unique blend of essential oils with their constituent compounds as claimed in claim 1, such that when lit, emanating vapors reduces the spread of germs in the area surrounding the candle of the present invention.

10. A germ solving candle comprising unique blend of essential oils with their constituent compounds as claimed in claim 1, such that when lit, emanating vapors eases symptoms of the common cold in human subject in need thereof.

11. A germ solving candle comprising unique blend of essential oils with their constituent compounds as claimed in claim 1, such that when lit, emanating vapors eases flu symptoms in human subject in need thereof.

12. A germ solving candle comprising unique blend of essential oils with their constituent compounds as claimed in claim 1, such that when lit, emanating vapors cleanse air of odor.

13. A germ solving candle comprising unique blend of essential oils and their constituent compounds as claimed in claim 1, such that when lit, emanating vapors repel insects.

14. A germ solving candle comprising unique blend of essential oils and their constituent compounds as claimed in claim 1, scent desired process, a process of creating different fragrances of the present invention, whereas increasing or decreasing the percentage amount of each constituent employed to the unique blend of essential oils, therefore allowing the unique blend of essential oils to produce a variety of different fragrances.

15. A germ solving candle comprising unique blend of essential oils with their constituent compounds as claimed in claim 14, whereas for scent desired propose, there for the candle of the present invention is produce in a variety of different fragrances.

16. A germ solving candle comprising unique blend of essential oils with their constituent compounds as claimed in claim 1, whereas for decorating propose the candle of the present invention is produce in a variety of candle types.

17. A germ solving candle comprising unique blend of essential oils with their constituent compounds as claimed in claim 1, whereas for decorating propose the candle of the present invention is produce in a variety of colors.

18. A germ solving candle comprising unique blend of essential oils with their constituent compounds as claimed in claim 1, additives whereas to improve candle flame quality are implemented, therefore reducing soot formation.
